(19) United States
(12) Patent Application Publication
(10) Pub. No.: US 2024/0096117 A1
(43) Pub. Date: Mar. 21, 2024

(54) MULTI-SPECTRUM CAMERA SYSTEM TO ENHANCE FOOD REGONITION

(71) Applicants: Crystal Jing Li, Palo Alto, CA (US); Evelyn Shen, Palo Alto, CA (US); Nash Young, Palo Alto, CA (US)

(72) Inventors: Crystal Jing Li, Palo Alto, CA (US); Evelyn Shen, Palo Alto, CA (US); Nash Young, Palo Alto, CA (US)

(21) Appl. No.: 17/933,848

(22) Filed: Sep. 20, 2022

(51) Int. Cl. G06V 20/68; G06V 10/143

(52) U.S. Cl. CPC G06V 20/68; G06V 10/143

(57) ABSTRACT

The described embodiments relate generally to a camera system to enhance food and material identification. More particularly, the described embodiments relate to using a plurality of camera sensors and LED light sources, including visible image sensors, visible light source, near infrared (NIR) image sensors, two or more bands of infrared light sources, depth camera images, and synchronized light source. The visible image data, NIR image data, depth image data are processed to obtain combined image data. A machine learning algorithm is employed to automatically compute an output based on the combined image data. The output includes information about the identity and the location of the food item.

### TECHNICAL FIELD OF THE INVENTION

The described embodiments relate generally to a camera system to enhance food and material identification. More particularly, the described embodiments relate to using a plurality of camera sensors and LED light sources, including visible image sensors, visible light source, near infrared (NIR) image sensors, 2 or more bands of infrared light sources, depth camera images, and synchronized light source. The visible image data, NIR image data, depth image data are processed to obtain combined image data. A machine learning algorithm is employed to automatically compute an output based on the combined image data. The output includes information about the identity and the location of the food item.

### BACKGROUND

Providing a robust and effective apparatus to identify food and material is challenging because of the wide variety of types of food and material around a kitchen and other places. Putting a wrong ingredient into food could ruin the food taste, potentially create some food pollution, and create other health issues in some cases. Additionally, food identification and preparation are often labor intensive and subject to human errors. Workers employed by businesses for food identification and preparation often require careful and sometimes excessive trainings, thus increasing costs. Food quality is also a critical issue in the agricultural sectors and food contamination remains at a high risk. Kitchen environments can vary widely and have a few challenges which makes food recognition processes difficult.

With technology advancements for the recent years, visible cameras have been widely used in many places for food and material identification, such as food sorting. Visible camera sensors, working in 400 nm-700 nm range, can identify food with different colors, shapes, or other visible characteristics. However, visible image sensors have challenges to identify food and material with similar color. Gases created during the cooking process, for example, also make collecting accurate image sensor data even more challenging.

There is strong need for improved systems and methods for recognizing and sorting food accurately and efficiently under different environment.

### SUMMARY OF THE INVENTION

Embodiments of the systems, devices, and methods, described in the present disclosure are directed to methods of using a plurality of multi-spectrum camera sensors to assist food identification and sorting. The visible image data, near infra-red (NIR) image data, depth image data are processed to obtain combined image data. A machine learning algorithm is employed to automatically compute an output based on the combined image data.

In one aspect, the system includes at least one camera sensor to capture RGB images in the visible light spectrum. The system may also include at least a visible LED light or other light source, which can be synchronized to the visible camera sensor to improve image quality.

In one aspect, the system includes at least one NIR camera sensor to capture NIR images. The system may also include two or more bands of NIR light sources, which can be synchronized to the NIR camera sensor. The NIR camera sensor can be based on II-IV, or III-V compound semiconductors, Quantum Film, or other type of organic film to provide good NIR sensitivity. NIR images captured at different NIR light sources will be used to improve the accuracy of food identification.

In one aspect, the system includes at least one depth camera system. The depth camera system can be based on a direct Time-of-Flight (dTOF) sensor, an indirect Time-of-Flight (iTOF) sensor, a structural light system, or other types of systems to provide accurate and high-resolution depth images.

In one aspect, the system may include two or more micro-processor or a System on Chip (SOC) to control the image sensors and light sources, to process, enhance, compress images, and save output images to a flash drive. Based on a real time image analysis, the SOC may provide control of the image sensors and the LEDs to adjust exposure time control, auto-gain control, and auto white balance; and to adjust the image sensor frame rates or the operating modes to obtain high quality images

In one aspect, various image processes, such as noise reduction, segmentation, etc., can be applied to captured images. A machine learning or cloud-based algorithm can be deployed to generate a combined point cloud image set. Calibration images stored in the flash drive or cloud drive can be used as an input to machine learning algorithm for the food and material identification.

In another aspect, the system may include battery and power control unit (PMU) to provide power supply to other system components. The system may also include a flash drive for image storage, dedicated display for imaging viewing and user interface, other interfaces such as USB connection to other mobile devices, and WiFi to connect to internet, etc.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows the block diagram of camera system in accordance with an embodiment of the invention.

FIG. 2 shows example of material reflection spectrum for both visible and NIR spectrum

FIG. 3A shows example of visible image for salt, sugar, and potato starch under visible light

FIG. 3B shows example of NIR images for salt, sugar, and potato starch under NIR light

FIG. 4 shows example of quantum efficient spectrum of InGaAs sensors to provide good sensitivity in both visible and NIR band from 400 nm to 1700 nm range

FIG. 5 shows example of quantum efficient spectrum of multiband near IR light source

FIG. 6 is a block diagram presentation of a method of system operation according to an embodiment of the invention.

### DETAILED DESCRIPTION

Reference will now be made in detail to representative embodiments illustrated in the accompanying drawings. Following description is not intended to limit the embodiments to one preferred embodiment. To the contrary, it is intended to cover alternatives, modifications, and equivalents as may be included within the spirit and scope of the described embodiments as defined by the appended claim. References are made to by ways of examples, and this is by no means limiting and a person with ordinary skills in the art may appreciate that a similar method in the invention may be used as well.

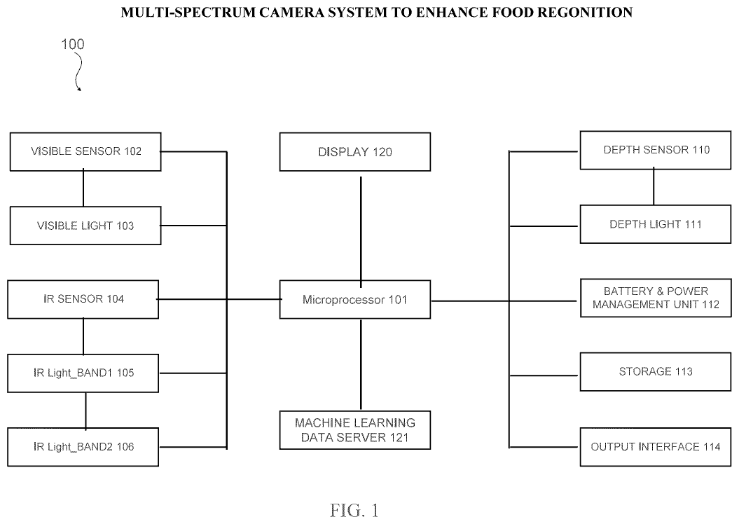

Reference is now made to FIG. 1, which illustrates the block diagram of image capture device 100 for food identification, according to one embodiment of the invention. The image capture device includes a microprocessor 101 to process all captured images and data. The device 100 also includes a visible camera sensor 102 for capturing visible color images. A visible light source 103 will be synchronized with the visible camera sensor 102 to provide light illumination in a low light environment.

The image capture device 100 also includes at least one near infrared (NIR) sensor 104 and two or more NIR light sources 105 and 106, which are working at different NIR bands. The NIR camera sensor 104 will provide a synchronized signal to the NIR light sources 105 and 106 to capture NIR images. NIR spectroscopy measures light that is scattered off and through a sample material, and this can be used to enhance food identification accuracy. This process has no impact on the material itself. This form of analysis requires little or no preparation of the sample and it can measure multiple objects in a single scan. It can also examine irregular surfaces. NIR imaging is therefore ideal as a method for analyzing different food sources.

The image capture device 100 also includes a depth camera 110 and a synchronized light source 111 to generate data on the distance of each point in the field of view from the device. The depth camera can be based on a direct Time-of-Flight (dTOF) sensor, an indirect Time-of-Flight (iTOF) sensor, a structural light system, or other types of systems to provide accurate and high-resolution depth images. The TOF camera is a range imaging camera system that resolves distance based on the known speed of light, measuring the time-of-flight of a light signal between the camera and the subject for each point of the image.

Image capture device 100 also includes a battery and power management unit 112, a flash drive 113 for image storage. The capture device 100 also includes a display 120 to show captured images and provide user interface information. The device 100 can also connect to a computer, a mobile phone, or a tablet through WIFI or USB cable connections. The device 100 can connect to machine learning data servers 121 or applications.

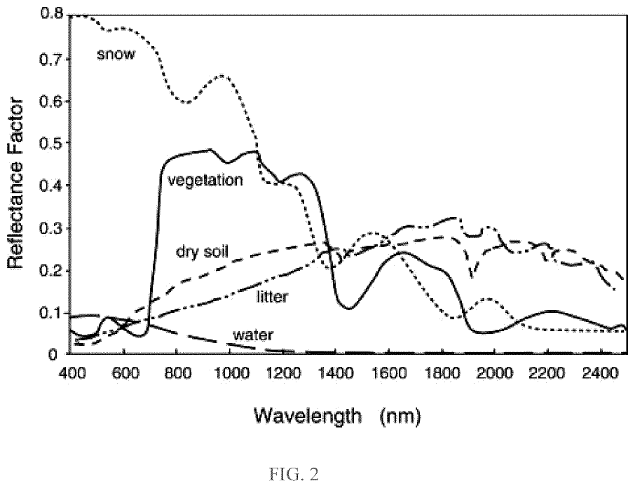

Reference is now made to FIG. 2, which shows example of reflectance spectrum from 400 nm to 2500 nm. Different materials have different reflection factors. For example, water has low reflection in visible wavelength range between 400 nm to 700 nm. Its reflection decreases at longer wavelength range and becomes very low beyond a wavelength of 1200 num. Snow, on the other hand, has very high reflection at visible light range and its reflection decreases at longer wavelength, but with several maxima and minima across the spectrum. Some vegetations, such as green leaves, also have low reflections at visible light range. Their reflections, however, increase significantly beyond 750 nm wavelength. These substances in food emit unique infrared lights. Therefore, NIR measurements can easily detect the existence of these substances a specific food compound. The concentrations of these substances can be expressed through the various levels of intensities at specific infrared wavelengths.

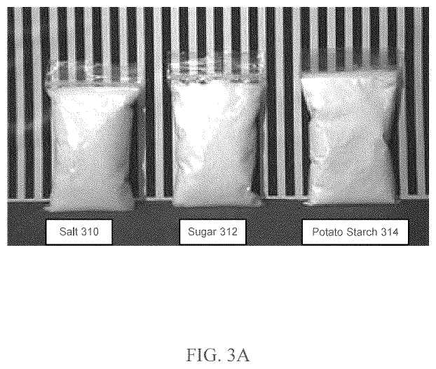

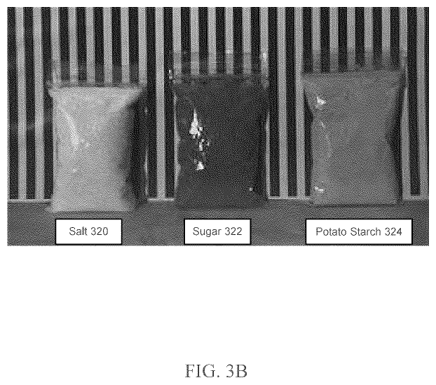

Reference is now made to FIG. 3A, which shows examples of visible images of salt 310, sugar 312, and potato starch 314. They all look very similar in the visible images, which may not be distinguishable from other white powders in a kitchen, such as baking soda, baking powder, white flour, etc. FIG. 3B shows NIR images taken under 1100 nm light conditions, sugar 322 becomes very dark at under a NIR light, potato starch 324 becomes slightly brighter, and salt 320 is the brightest due to high reflection at this NIR wavelength. These substances can be easily distinguished using NIR images. As shown in FIG. 2, light reflection of a substance can change significantly from visible light, ranging from 400 nm-700 nm, to NIR spectrum, ranging from 800 nm-1700 nm wavelength. By combining with visible images and NIR images from different wavelengths, the food and material identification process can be made more easily and accurately.

For image sensing applications in the visible light and near IR spectral ranges, up to about 1000 nm, silicon image sensor arrays are generally the technology of choice. Silicon image sensor chips with high resolution (i.e., fine pitch) and high sensitivity are inexpensive and widely available. At longer wavelengths, however, the absorption reduces significantly due to Si bandgap. In fact, beyond about 1100 nm, thin wafers of silicon are essentially transparent.

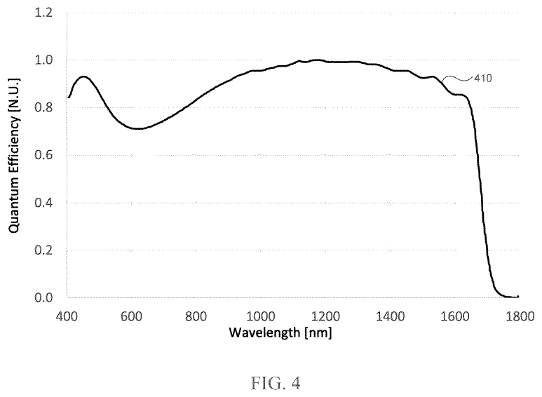

Near IR sensors may comprise various sorts of IR-sensitive materials, such as a semiconductor material with II-VI or III-V compounds, organic photodiodes or a quantum film, i.e., a colloidal film comprising quantum dots engineered for sensitivity in the desired wavelength bands. FIG. 4 shows an example of quantum efficient spectral response of an InGaAs image sensor. The image sensor design has been optimized to achieve a good sensitivity from 400 nm to 1700 nm range. This InGaAs sensor, is a very good candidate for NIR imaging. To get good quality NIR images, high efficient and narrow band NIR light sources also need to be carefully chosen.

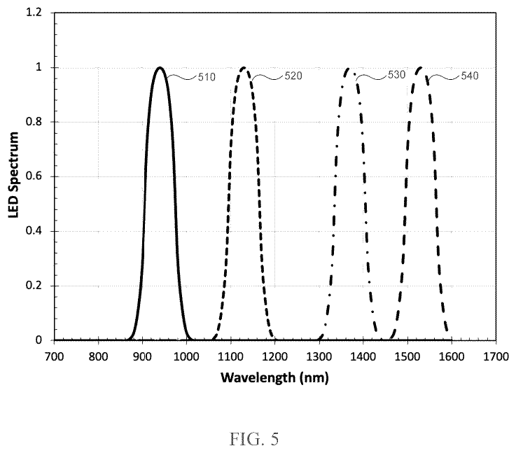

As shown in FIG. 2, different materials have different light reflections in both visible light and NIR ranges. In order to improve accuracy of material identification, one embodiment of the invention is to use two or more bands of NIR light sources. FIG. 5 shows an example of an NIR light source with a spectrum having different peak wavelengths, e.g., a 940 nm peak for the light source 510, a 1130 nm peak for the light source 520, a 1360 nm peak for the light source 530, and a 1550 nm peak wavelength for the light source 540. Compared to a single IR image, the identification accuracy can be significantly improved with two or more different NIR light and each at different wavelength. It is preferred to choose NIR light source to cover different NIR bands to improve identification accuracy, while still within NIR sensor operating wavelength range.

Atypical image sensor for either visible light or NIR includes one of a strobe control signal output. The strobe signal is synchronized with the image sensor readout vertical blanking period. The strobe signal will provide a sync signal input to power management unit, which will generate a synchronized control signal to turn on the corresponding LEDs or other light sources. The synchronization control between the image sensor and light sources will reduce image sensor motion artifact, increase image signal to noise ratio, at same time reduce power consumption.

Each image sensor in the image device 100 is calibrated with a calibration target capable of obtaining known high signal-to-noise ratio observations. Those calibration data will store either on the cloud server or a device storage device.

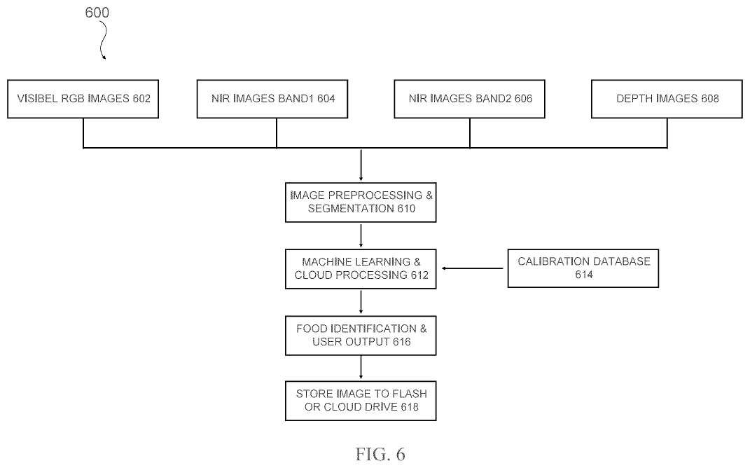

Reference is now made to FIG. 6, which shows a working flow to capture images of food sources from multiple sensors in accordance with an embodiment of the invention. Multiple sensor images are captured and pre-processed, including visible images 602, first NIR images with first band of NIR light 604, second NIR images with second band of NIR light 606, and depth image 608. Image preprocessing and segmentation 610 are applied on all combined images, then combined images are processed through machine learning algorithm 612, with the cloud processing and calibration database 614 as extra inputs. Based on all these inputs, machine learning algorithm 612 can provide food identification information 616 and output such information to a user interface. The images can be stored in flash drive or cloud drive 618. The image data or portions of the image data are presented to a human user to confirm material type. Inputs from the human user are then fed back to machine learning based algorithm 612 to expand the material database and improve the accuracy for future food and material identification. With a continuous tuning, accuracy of food and material identification can be significantly improved.

What is claimed is:

1. A method to identify food using a multi-spectrum camera system, comprising:
providing a multi-spectrum camera system including a microprocessor, a plurality of camera sensors and light sources, a flash drive storage, a display, a USB interface and/or WiFi interface;
capturing a set of visible images;
capturing a set of NIR images with a first band NIR light source;
capturing at least a second set of NIR images with a second band of NIR light source;
capturing a set of depth images;
pre-processing of the visible images, the first set of NIR images, the second set of NIR images, and the depth images;
segmenting of the visible images, the first set of NIR images, the second set of NIR images, and the depth images;
combining the visible images, the first set of NIR images, the second set of NIR images, and the depth images into point cloud images;
calibrating the multi-spectrum camera system with known reference materials;
applying a machine-learning or a cloud-based process algorithm to the point cloud images;
interfacing with other devices; and
displaying the point cloud images and corresponding food identification.

2. The method in claim 1, wherein the plurality of camera sensors and light source include:
at least one visible camera sensor;
at least one visible light source;
at least one NIR camera sensor;
two or more NIR light sources;
at least one depth camera sensor; and
at least one light source for depth camera sensors.

3. The method in claim 2, wherein the visible camera sensor is a Silicon based CMOS image sensor.

4. The method in claim 2, wherein the at least one visible camera sensor and the at least one visible light source are synchronized.

5. The method in claim 2, wherein the at least one NIR camera sensor is compound semiconductor based.

6. The method in claim 2, wherein the at least one NIR camera sensor includes organic photodiodes.

7. The method in claim 2, wherein the at least one NIR camera sensor is a quantum film.

8. The method in claim 2, wherein the two or more NIR light sources emit different NIR lights at different wavelengths.

9. The method in claim 2, wherein the at least one NIR camera sensor and two or more NIR light sources are synchronized.

10. The method in claim 2, wherein the at least one depth camera sensor is a direct Time-of-Flight (dTOF) sensor.

11. The method in claim 2, wherein the at least one depth camera sensor is an indirect Time-of-Flight (iTOF) sensor.

12. The method in claim 1, further comprising providing a structural light.

13. The method in claim 1, further comprising
controlling the plurality of camera sensors and light sources;
processing and enhancing the point cloud images;
compressing the point cloud images;
segmenting the point cloud images; and
saving the point cloud images.

14. The method in claim 1, further comprising applying the machine-learning or the cloud-based process algorithm to one or more of the visible images, the first set of NIR images, the second set of NIR images, or the depth images.

15. The method in claim 1, wherein the calibrating the multi-spectrum camera system with known reference materials includes generating calibration images and storing the calibration images in the flash drive storage or a cloud storage. can be used as an input to machine learning algorithm for food and material identification.

16. The method in claim 15, further comprising inputting the calibration images into the microprocessor.

17. The method in claim 1, further comprising a battery and a power management unit.

18. The method in claim 1, further comprising a display.

19. The method in claim 1, further comprising transferring the point cloud images through the USB interface or the WiFi interface.

20. A multi-spectrum camera system for food identification, comprising:
a microprocessor;
a plurality of camera sensors and light sources;
a battery;
one more power management units (PMU);
a flash drive storage;
a display;
a USB and/or a WiFi interface;
a first band NIR light source;
a second band of NIR light source; and
a depth camera sensor.
